(19) United States
(12) Patent Application Publication
(10) Pub. No.: US 2016/0350421 A1
(43) Pub. Date: Dec. 1, 2016

(54) PERSONAL SEARCHABLE DOCUMENT COLLECTIONS WITH ASSOCIATED USER REFERENCES

(71) Applicant: BOYD CANNON MULTERER, BELLEVUE, WA (US)

(72) Inventor: BOYD CANNON MULTERER, BELLEVUE, WA (US)

(21) Appl. No.: 15/158,547

(22) Filed: May 18, 2016

Related U.S. Application Data
(60) Provisional application No. 62/230,316, filed on Jun. 1, 2015.

(51) Int. Cl. G06F 17/30

(52) U.S. Cl. CPC G06F 17/30864; G06F 17/30011

(57) ABSTRACT

The present invention relates to user searches of the Internet, document repositories, online reporting agencies, information databases, social media outlets, audio or video images, or any other desirable searchable media or information. According to the present invention, a user may perform a search and may take into account certain users or user groups who may have previously searched out the same items so that a user can limit or influence its current search taking into account prior user searches for particular prior user purposes. Accordingly, users may curate their searches based on the information entered by other users or even the same user during previous searches, so that the universe of searched resources may be limited to those most likely to pertain to that user search, based on previous users or subsets of users as selected by the user, that is, crowd sourced curation of metadata.

### CROSS-REFERENCE TO RELATED APPLICATION

This application is an original non-provisional patent application claiming the priority benefit of provisional patent application Ser. No. 62/230,316 filed Jun. 1, 2015, the contents of which are incorporated herein by reference.

### BACKGROUND OF THE INVENTION

There have been many methods of saving and organizing documents from the Internet. Bookmarking has been very prevalent for a number of years, but the diversity of information sources has lead to a need for a more detailed and more intuitive way to manage that which has been viewed, both from personal computers and smart phones. Many users tend to sort traditional bookmarks into folders and sub folders, collections of favorites, saved web histories and more. These bookmarks often grow to a huge and often disorganized state that is hard to navigate and therefore difficult to locate a path to the desired document. Search engines are very good at indexing documents but with the almost infinite amount of documents available it can be quite difficult to find an exact document you are searching for. There have also been a variety of methods for sharing documents of interest with a group of people with a particular interest or even with the public in general. One may send a tweet using the Twitter service containing the document URL or post the URL to a social media site such as Facebook or LinkedIn. One may also email or massage the link to individuals or groups. These methods are useful but they fall short in their ability to save organize, search and share documents of interest.

Searching isn't new. Indexing pages isn't new. Sharing your bookmarks isn't new. Recently, a few entities have tried to improve search-ability. The company known as Delicious disclosed web-based bookmarking and sharing sites with other users to gain traction. Delicious has many shortcomings. While Delicious could facilitate adding links, which may be searched and shared, it is a broadcasting service, much like Twitter. It has no facility for detailed searching or metadata searching and indexing for your own personal private use or distribution within a limited group or organization. Delicious lacks combined indexes and lacks metadata searches.

Another company in this area included Pocket. Pocket is a tool for reading “later”, and has some formatting ability. Links may be dropped into a pocket, and then, it caches those pages on your device so you can read them later even when you don't have connectivity. Formatting for user (that is, the one dropping the links into the pocket) read-ability purposes is disclosed. For example, the user can search into his or her Pocket collection, but it is totally devoid of sharing features, both with other individual users or other users within a common work group or association. Pocket is also devoid of hierarchy forming and searching, and is completely not equipped for intuitive marking and indexing of images or documents viewed from a wide array of sources for sharing with a defined group of people. Another similar online service to Delicious is called Evernote. Evernote permits a user to drop web pages into folders and then search them. While it suggests “team usage”, it totally lacks useful metadata and hierarchy aspects, and does not have the ability to both share and limit access to the hierarchy of “bookmarked” documents or images. Services like Google, Bing and others are confined to master document indices, and do attempt to take advantage of “implied” contacts or social links. If such services “know” who you communicate with, the services will attempt to tune search results to what a user searches. That is, these services fail to teach or suggest the use of “explicit” social relationships or contacts to form that combined library to search into (i.e., the user does not ultimately get to control which social connections or contacts are being searched and they do not permit a user to fine tune or limit the relevancy of such links. Much of the indexing hinges of word relevancy and other machine learning techniques. However, these services lack the arbitrary combined indices based on people you know or choose to add, whether in an organization or not. That is, a social network with both private and public attributes built around bookmarked references is not taught. Accordingly, building groups (working, social or private and-or public, or otherwise) around bookmarks is not taught. That is, you cannot search documents from certain people who you know worked together on a particular topic or interest. Likewise, you cannot search for people with particular bookmark interests. Well known in the social media arena, Facebook and Twitter index documents and are more social in nature, but they are all about the “news stream”, or what is public facing, and not at all analytical. What is lacking in the prior art is information retention. Documents and images fly by and are gone. What is lacking is a slow-social place where users can browse and search documents from a team of their choosing, not ephemeral in nature.

### SUMMARY OF THE INVENTION

The following invention is generally concerned with Personal Searchable Document Collections with Associated User References. A method of gathering, storing, annotating, and if one chooses sharing publicly or with an individual or a select group, any number of items, hereto referred to as a document, that have a location (commonly referred to as a URL) on the internet associated with them. These “documents” include, but are not limited to, written articles & stories, blogs, photographs, videos & animations, geographic locations (latitude and longitudes, counties, states, cites, neighborhoods etc), buildings and businesses, websites, sporting events, recipes, comics & illustrations and social media profiles for individuals or entities. The references associated with these documents include, but are not limited to, the document's URL, the title of the document, the reference creators identification, non alpha-numeric tags such as hash tags to denote a topic or subject matter of interest contained in or relevant to the document, date and time the document was added to the user's collection, location of the user when added to the collection and privacy settings of the document in the user's collection. As mentioned a document refers to any number of items that have a location on the Internet, a URL, associated with them. References are a user's link to the document and their unique user metadata associated with a document. There can be many unique user references to a single document. When using the system users do not see the document object, only their, or other users, personalized references to the document. It is a user's personal curated view of the Internet. The addition of hash tags and hash paths (an example of a hash path #environment#water#fracking) to the user's reference, gives the user a rapid and easy methodology for labeling, categorizing, storing and then searching references that they have added to their collection, or finding references in a shared collection, and then finding the documents that meet their desired criteria. The hash tags and hash paths are used to create a topic tree for each individual user of the system. It should be noted that any non-alphanumeric symbol could be used in place of a hash tag. The hash tag (#) is the most commonly used symbol at the time of this disclosure and those skilled in the art could accommodate the use of practically any symbol when designing the system described herein. It will become evident from the following disclosures, particularly the preferred embodiments, that this new and unique system of Personal Searchable Document Collections with Associated User References can provide an array of novel and useful tools and resources to users of the system described herein.

It is the primary objective of the invention to provide Personal Searchable Document Collections with Associated User References that allow people to save annotate and share any object with an associated location on the Internet, which is missing from the prior art.

It is a further objective of the invention to provide methods for creating unique user references to these collected documents allowing for new methods of saving, storing, sorting, searching for and sharing of objects with an associated location on the Internet.

It is a further objective of the invention to provide a topic list or “topic tree” that is generated from hash tags and hash paths that are associated with unique document references.

With the present invention, it is important to enable searching into arbitrarily grouped indexes. In other words, searching into the combination of a user's bookmarks or the bookmarks of another person of interest. This allows teams to have a shared library of documents they can search. Each person maintains their own list of relevant information and the team benefits. In one example, a school can use the present invention. For example, a 3rd grade teacher may have a set of links to content they think is helpful, such as math resources or history, etc. A parent can then browse/search through the combined set of information from all the 3rd grade teachers in the school, and then add that set to the parent's own research, etc. Accordingly, being able to search into the library of “curated” information from your team/associates/friends is very valuable, according to the present invention. Being able to search from local documents and private documents, from all sources and websites and portals is important as well. Accordingly, with the present invention, searching into collections of “curated” content instead of searching the vast unwashed Internet is valuable according to the present invention. Everything you see upon a search was interesting enough to be added by a real person. You can arbitrarily combine different people's libraries into a new library of curated content. Typical modern search engines have a master index of all the documents (the web). They pull data from a user's friends and your own behavior to do great predictions about what you might want to see. Because according to the present invention, a user curated content, a user can include metadata from when any user added that link their respective library. When did that happen? Where were they? Was it in the context of a science reading, Bing, or some other resource? Or were they listening to music? Was it on a phone in a specific museum? The user can also add a personal text description or “review” to the link. Accordingly, a given link may be added into a thousand libraries from a thousand users. The page it points to is the same each time (like a standard search engine), but the metadata associated with that link in that library is different each time. One user may, for example, say a reference is about say raising chickens in the description, while another may say it is about sustainable farming. A third user searching a library that includes the previous two would get the benefits of both descriptions.

Another way the present invention may be helpful is if a user is in a museum. With the present invention, users may now see the links from whatever group library he or she is searching that were added from other users in the same museum. The point here is to reduce the set of documents being searched by using user-specific metadata. According to the present invention, each search set is reduced from the whole Internet to a library added by an arbitrary collection of people. This aspect of the present invention further reduces that set to just those documents that have relevant metadata attached to them, for example, a location or documents added in a certain time window. By way of another example, a document on the Internet may be ten years old, but what is truly critical is that a user added it to the library two months ago during a research project he or she did with two other people. Users would find it advantageous to search the combined library of the three users, and then further restrict the search only to documents added during the research project. Accordingly, with the present invention, less or no emphasis is placed on when the docs were created, only when the users of interest to the present user added them to their library. Another advantageous aspect of the present invention is to form a strong hierarchy via so-called “hash paths”. This is actually a specific form of metadata from a user when the link was added to the library. According to the present invention, such data may be referred to as “#Hash#Path”, somewhat akin to a Twitter hash tag. With Twitter, you can add a hash tag in the form of #newsworthy or something like that. Later, people can follow the #newsworthy tag in a tweet search and get a stream of tweets from lots of people that included the same hash tag. In the past, topic trees have had topic paths, such as: (news/politics/national/elections), (news/politics/democrat), (news/politics/republican), (news/international/Germany) and so on. A structured format was often prescribed by a centralized organization. For example, Yahoo adopted this format. This approach is relies on human intervention and generation and not generally scalable. Conversely, according to the present invention, searches and results may be for the first time CROWD SOURCED, so that users interesting in searching get the benefit of the searches of other users, where the searching user controls which users are of import and which criteria and information is of import. Accordingly, a searching user can include a hash path in the form of #news#politics#national. This assigns a user-curated topic to the user's instance of a link in his or her library. Because it is a path with multiple elements, it can be used to form a hierarchical tree of content, except, CROWD SOURCED, so scalability is deeply enhanced. Accordingly, when a user does a search into a combined library, the user can reduce the number of documents being searched by adding #news#national to his or her search. This reduces the combined library to just the documents that have been tagged to the #news topic and again to the #national sub-topic under #news. This is across all the libraries of all the people in that user's combined search.

According to the present invention, this will also permit the user to browse through trees of links.

So, you may be searching terms on discrete databases: GitHub, Medium, the web, some home-rolled websites, etc. With the present invention, a single place is provided whereby a user can browse and search all the documents from all the sources, such as all the presenters at a given convention, etc. So if you are attending a convention, such as Ruby Con, the organizers would ask convention attendees to include a hash path something like #rubyconf#2015#topic area.

A better understanding can be had with reference to the detailed description of preferred embodiments, which follows along with reference to the appended drawings.

### BRIEF DESCRIPTION OF THE DRAWINGS

FIG. 1 is a flowchart illustrating a method for creating document references of the invention.

FIG. 2 is a flowchart illustrating an alternate method for creating document references of the invention.

FIG. 3 is a flowchart illustrating a basic search method of the invention.

FIG. 4 is a flowchart illustrating an alternate search method of the invention.

FIG. 5 is a flowchart illustrating an alternate search method of the invention.

FIG. 6 is an illustration showing a representation of a topic tree for a specific user of the system.

### DETAILED DESCRIPTION OF THE PREFERRED EMBODIMENT

In accordance, preferred embodiments of the inventions, Personal Searchable Document Collections with Associated User References, are provided. It will be appreciated that each of the embodiments described include methods and that the methods of one preferred embodiment may be different than the methods of another embodiment. The preferred embodiments described herein are not the sum total of the invention but merely contain certain methods of how the disclosed invention may provide unique experiences to users of the system. According to the present invention, a user adds a document to the system and a user adds reference data to be associated with document, hash tags or hash paths etc. Database checks to see if a document already exists in the database is also performed. If no, the document is added to the database (hereinafter “DB”) and a document is “crawled” (A crawler is a program that visits Web sites and reads their pages and other information in order to create entries for a search engine index.) and a user's unique reference is added. (User is tagged as originator of document) Other crawled information about the document is added to DB, publication date, author, document size, file type, formatting, geo-location, etc. A potential list of what is crawled is set forth herein.

If yes, a user's new unique reference to existing document is added. A user's hash tags and other information are associated with references and specific to user are added. User's hash tags and hash paths are added to their topic trees. A user may now search and find personal references using any of above information.

If public or available to a group others may find using same info or partial piece of data in the reference. A user may search others public or permitted reference collections (the “Reference”) using similar information.

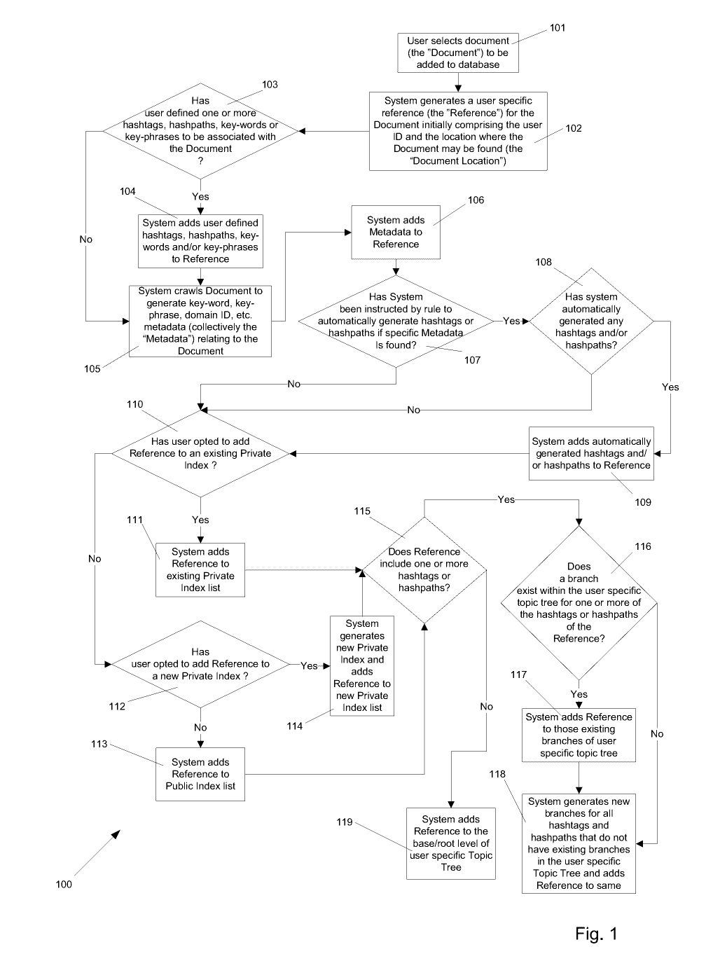

FIG. 1 is a flowchart 100 illustrating a method for creating a document reference of the invention. In step 101 a user of the system selects the document (the “Document”) to be added to the system database. The Document will typically be but is not limited to the content of a webpage. Examples of other forms of document may be an Excel file stored on a local server, a video, or a musical track. It should be appreciated that the term document as used herein is meant in the very broadest term and refers to an item of interest that the user of the system wishes to create a reference for. The flowchart then branches to step 102. In step 102 the system generates a user specific reference (the “Reference”) to the selected document that initially includes the user ID and the location where the document may be found (the “Document Location”). The Document Location will typically be but is not limited to a URL. The flowchart then branches to step 103. In step 103 the system determines if the user has defined one or more hash tags, hash paths, keywords or key-phrases to be associated with the document. If the user has defined one or more hash tags, hash paths, keywords or key-phrases to be associated with the document the flowchart branches to step 104. If the user has not defined one or more hash tags, hash paths, keywords or key-phrases to be associated with the document then the flowchart branches to step 105. In step 104 the system adds the user-defined hash tags, hash paths, keywords and/or key-phrases to the Reference. The flowchart then branches to step 105. In step 105 the system crawls the Document to generate metadata relating to the Document. The term “crawl” refers to analyzing the content and other characteristics of the document to generate metadata such as keywords, key-phrases, URL data, the Domain ID, etc. A much more complete but by no means all encompassing list of information that may be gleaned by a “crawl” of the document is provided below. The flowchart then branches to step 106. In step 106 the system adds the Metadata gleaned by the crawl to the Reference. The flowchart then branches to step 107. In step 107 the system determines if any rules are in place instructing the system to automatically generate hash tags or hash paths if specific Metadata is found. If such rules are in place the flowchart branches to step 108. If such rules are not in place the flowchart branches to step 110.

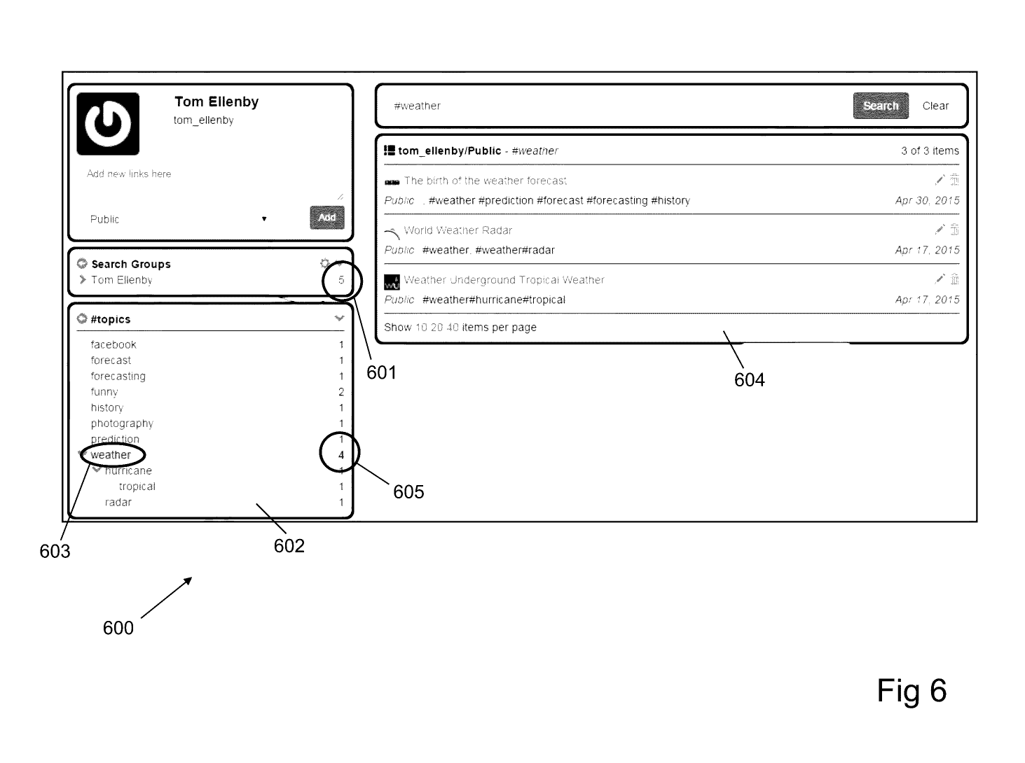

In step 108 the system determines if any hash tags and/or hash paths have been automatically created by rule. If hash tags and/or hash paths have been automatically created by rule the flowchart branches to step 109. If hash tags and/or hash paths have not been automatically created by rule the flowchart branches to step 110. In step 109 the system adds hash tags and/or hash paths automatically created by rule to the Reference. The flowchart then branches to step 110. In step 110 the system determines if the user of the system has opted to add the Reference to an existing Private Index associated with that user. If the user of the system has opted to add the Reference to a Private Index the flowchart branches to step 111. If the user of the system has not opted to add the Reference to a Private Index the flowchart branches to step 112. In step 111 the system adds the Reference to the selected existing Private Index list. The flowchart then branches to step 115. In step 112 the system determines if the user of the system has opted to add the Reference to a new Private Index associated with that user. If the user of the system has opted to add the Reference to a new Private Index the flowchart branches to step 114. If the user of the system has not opted to add the Reference to a new Private Index the flowchart branches to step 113. In step 114 the system generates the new user associated Private Index and adds the Reference to the new Private Index list. The flowchart then branches to step 115. In step 113 the system adds the Reference to the Public Index list. The flowchart then branches to step 115. In step 115 the system determines if the Reference include one or more hash tags or hash paths. If the system determines that the Reference does not include one or more hash tags or hash paths the flowchart branches to step 119. In step 119 the system adds the Reference to the base/root level of the topic tree associated with the user of the system (the “Topic Tree”). In this way a reference may not appear in a branch of the Topic Tree but the reference may still be located in the Topic Tree by searching for keywords etc. that are part of the metadata. If the system determines that the Reference does include one or more hash tags or hash paths the flowchart branches to step 116. In step 116 the system determines if a branch in the Topic Tree already exists for one or more of the hash tags or hash paths of the Reference. If a branch in the Topic Tree already exists for one or more of the hash tags or hash paths of the Reference the flowchart branches to step 117. If a branch in the Topic Tree does not already exist for one or more of the hash tags or hash paths of the Reference the flowchart branches to step 118. In step 117 the system adds the Reference to those existing branches of the user specific Topic Tree. The flowchart then branches to step 118. In step 118 the system automatically generates new branches of the Topic Tree for all hash tags and hash paths of the Reference that do not have pre-existing branches in the user specific Topic Tree and adds the Reference to same. In this way new branches of the Topic Tree will be automatically created and populated by the system. It should be noted that, depending on the hash tags and hash paths of the Reference, a Reference may be added to multiple branches of the user's Topic Tree. A better understanding of the user specific Topic Tree may be gained by reference to FIG. 6 below.

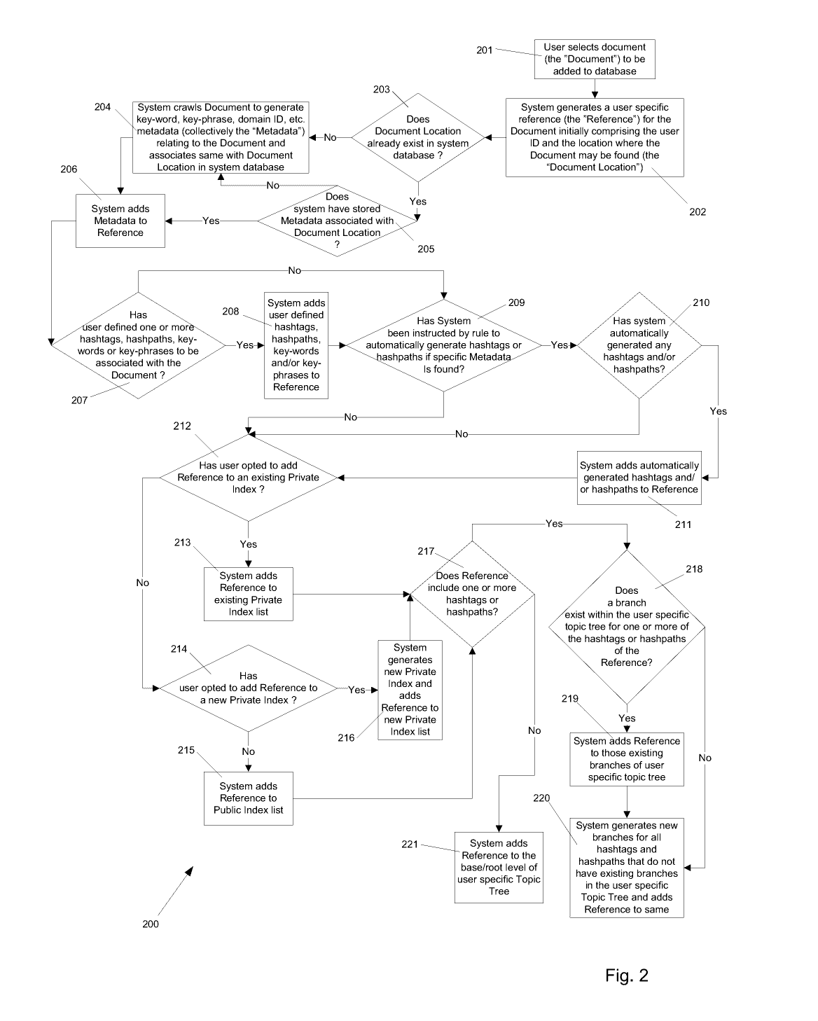

FIG. 2 is a flowchart 200 illustrating an alternate method for creating a document reference of the invention. In step 201 a user of the system selects the document (the “Document”) to be added to the system database. The Document will typically be but is not limited to the content of a webpage. Examples of other forms of document may be an Excel file stored on a local server, a video, or a musical track. It should be appreciated that the term document as used herein is meant in the very broadest term and refers to an item of interest that the user of the system wishes to create a reference for. The flowchart then branches to step 202. In step 202 the system generates a user specific reference (the “Reference”) to the selected document that initially includes the user ID and the location where the document may be found (the “Document Location”). The Document Location will typically be but is not limited to a URL. The flowchart then branches to step 203. In step 203 the system determines if the Document location already exists in the system database. If the Document Location does already exist in the system database the flowchart branches to step 205. If the Document Location does not already exist in the system database the flowchart branches to step 204. In step 205 the system determines if the database contains Metadata associated with the Document Location. If the database does not contain Metadata associated with the Document Location the flowchart branches to step 204. If the database does contain Metadata associated with the Document Location the flowchart branches to step 206. In step 204 the system crawls the Document to generate metadata such as key-words, key phrases, the domain ID, etc., relating to the Document and associates the same metadata with the Document Location in the system database. The flowchart then branches to step 206. In step 206 the system adds the Metadata to the Reference. The flowchart then branches to step 207. In step 207 the system determines if the user has defined one or more hash tags, hash paths, keywords or key-phrases to be associated with the document. If the user has defined one or more hash tags, hash paths, keywords or key-phrases to be associated with the document the flowchart branches to step 208. If the user has not defined one or more hash tags, hash paths, keywords or key-phrases to be associated with the document then the flowchart branches to step 209. In step 208 the system adds the user-defined hash tags, hash paths, key-words and/or key-phrases to the Reference. The flowchart then branches to step 209. In step 209 the system determines if any rules are in place instructing the system to automatically generate hash tags or hash paths if specific Metadata is found. If such rules are in place the flowchart branches to step 210. If such rules are not in place the flowchart branches to step 211. In step 210 the system determines if any hash tags and/or hash paths have been automatically generated by rule. If hash tags and/or hash paths have been automatically created by rule the flowchart branches to step 211. If hash tags and/or hash paths have not been automatically created by rule the flowchart branches to step 211. In step 211 the system adds hash tags and/or hash paths automatically created by rule to the Reference. The flowchart then branches to step 212. In step 212 the system determines if the user of the system has opted to add the Reference to an existing Private Index associated with that user. If the user of the system has opted to add the Reference to a Private Index the flowchart branches to step 213. If the user of the system has not opted to add the Reference to a Private Index the flowchart branches to step 214. In step 213 the system adds the Reference to the selected existing Private Index list. The flowchart then branches to step 217. In step 214 the system determines if the user of the system has opted to add the Reference to a new Private Index associated with that user. If the user of the system has opted to add the Reference to a new Private Index the flowchart branches to step 216. If the user of the system has not opted to add the Reference to a new Private Index the flowchart branches to step 215. In step 216 the system generates the new user associated Private Index and adds the Reference to the new Private Index list. The flowchart then branches to step 217. In step 215 the system adds the Reference to the Public Index list. The flowchart then branches to step 217. In step 217 the system determines if the Reference includes one or more hash tags or hash paths. If the system determines that the Reference does not include one or more hash tags or hash paths the flowchart branches to step 221. In step 221 the system adds the Reference to the base/root level of the user specific topic tree associated with the user of the system (the “Topic Tree”). In this way a reference may not appear in a branch of the Topic Tree but the reference may still be located in the Topic Tree by searching for keywords etc., that are part of the metadata. If the system determines that the Reference does include one or more hash tags or hash paths the flowchart branches to step 218. In step 218 the system determines if a branch in the Topic Tree already exists for one or more of the hash tags or hash paths of the Reference. If a branch in the Topic Tree already exists for one or more of the hash tags or hash paths of the Reference the flowchart branches to step 219. If a branch in the Topic Tree does not already exist for one or more of the hash tags or hash paths of the Reference the flowchart branches to step 220. In step 219 the system adds the Reference to those already existing branches of the user specific Topic Tree. The flowchart then branches to step 220. In step 220 the system automatically generates new branches of the Topic Tree for all hash tags and hash paths of the Reference that do not have existing branches in the user specific Topic Tree and adds the Reference to same. In this way new branches of the Topic Tree will be automatically created and populated by the system. It should be noted that, depending on the hash tags and hash paths of the Reference, a References may be added to multiple branches of the Topic Tree.

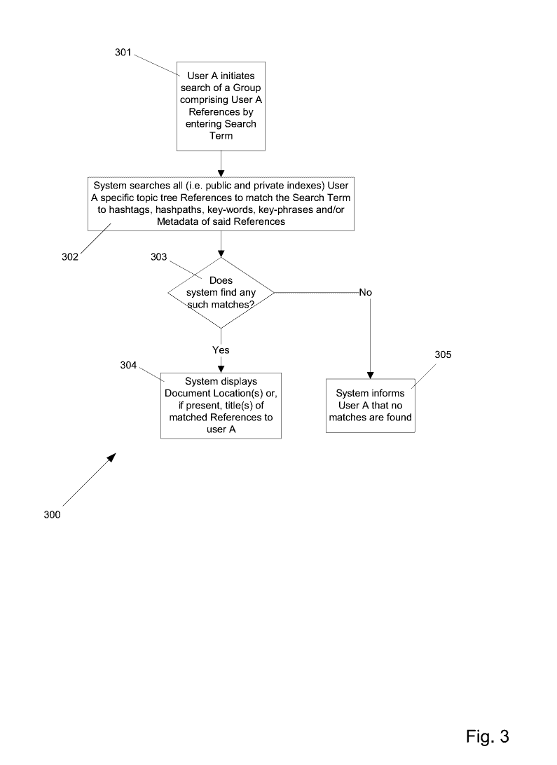

FIG. 3 is a flowchart 300 illustrating a basic search method of the invention in which a user of the system restricts the search to References in their own Topic Tree. In step 301 user A of the system initiates a search comprising the Group “User A References” (in other words user A is only searching their own Topic Tree) by entering a search term such as a keyword, phrase, etc. (the “Search Term”). The flowchart then branches to step 302. In step 302 the system searches all (i.e. public and all private indexes) User A Topic Tree References to match the Search Term to the hash tags, hash paths, keywords, key-phrases and/or Metadata of the References in User A's Topic Tree. The flowchart then branches to step 303. In step 303 the system determines if any such Search Term matches where found. If Search Term matches where found the flowchart branches to step 304. If Search Term matches where not found the flowchart branches to step 305. In step 304 the system displays the Document Locations or, if present, the title associated with the matched References to User A. It should be noted that References may have been given titles, either by the user or automatically by the system based upon the Metadata of the Document, and these titles may be displayed instead of the actual Document Location. In Step 305 the system inform User A that no matches to the Search Term have been found.

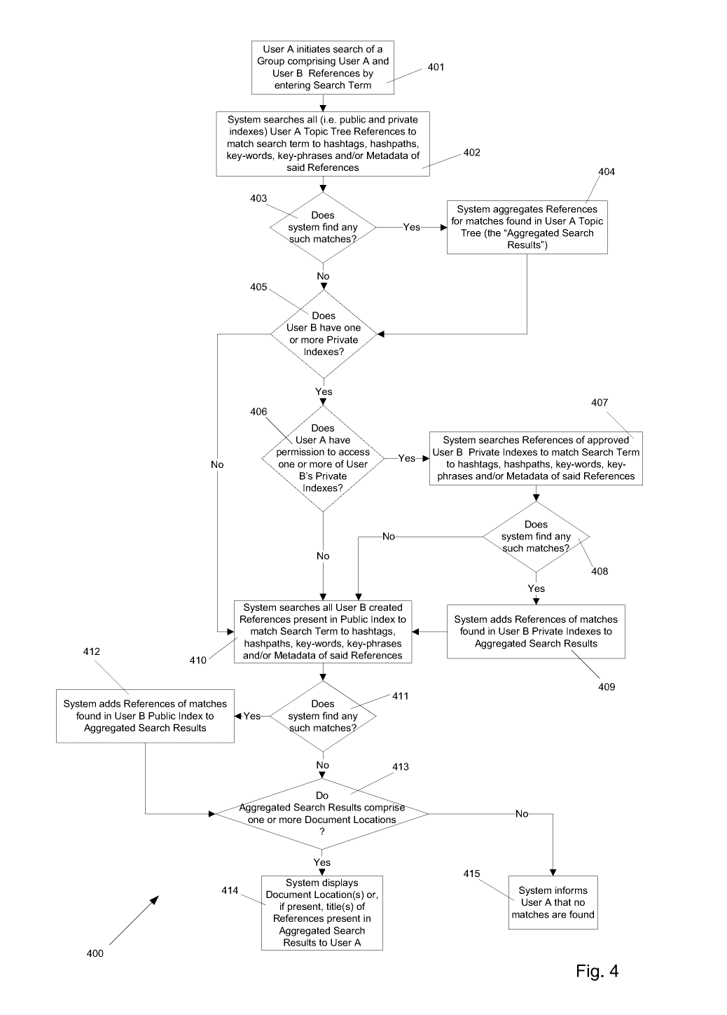

FIG. 4 is a flowchart 400 illustrating an alternate search method of the invention in which a user of the system (User A) searches the References in their own Topic Tree and the References in a second users (User B) Topic Tree. In step 401 User A initiates the search of a group comprised of User A and User B references by entering a search term such as a keyword, phrase, etc. (the “Search Term”). The flowchart then branches to step 402. In step 402 the system searches entire (i.e. public and all private indexes) User A Topic Tree to match the Search Term to the hash tags, hash paths, key-words, key-phrases and/or Metadata of the References in User A's Topic Tree. The flowchart then branches to step 403. In step 403 the system determines if any such Search Term matches where found. If Search Term matches where found the flowchart branches to step 404. If Search Term matches where not found the flowchart branches to step 405. In step 404 the system aggregates the References associated with the matched Search Term found in User A's Topic Tree (the “Aggregated Search Results”). The flowchart then branches to step 405. In step 405 the system determines if User B has one or more Private Indexes. For example, User B may have a Private Index “Work” that only he has access to. If the system determines that User B does have one or more Private indexes the flowchart branches to step 406. If the system determines that User B does not have one or more Private indexes the flowchart branches to step 410. In step 406 the system determines if User A has permission to access one or more of User B's Private Indexes. For example, User B may have a Private Index “Family” and has only granted password-protected access to this Index of References to specific family members. If the system determines that User A does have permission to access one or more of User B's Private indexes the flowchart branches to step 407. If the system determines that User A does not have permission to access one or more of User B's Private indexes the flowchart branches to step 410. In step 407 the system searches References of User B Private indexes that user A has approved access in order to match the Search Term to the hash tags, hash paths, key-words, key-phrases and/or Metadata of the References in User B's Private Index Topic Trees. The flowchart then branches to step 408. In step 408 the system determines if any such Search Term matches where found. If Search Term matches where found the flowchart branches to step 409. If Search Term matches where not found the flowchart branches to step 410. In step 409 the system adds the References for the matches found in approved User B Private Indexes to the Aggregated Search Results. The flowchart then branches to step 410. In step 410 the system searches all references created within User B's Public Index to match the Search Term to the hash tags, hash paths, keywords, key-phrases and/or Metadata of the References in User B's Public Index Topic Tree. The flowchart then branches to step 411. In step 411 the system determines if any such Search Term matches where found. If Search Term matches where found the flowchart branches to step 412. If Search Term matches where not found the flowchart branches to step 413. In step 412 the system adds the References for the matches found in User B's Public Index to the Aggregated Search Results. The flowchart then branches to step 413. In step 413 the system determines if the Aggregated Search Results comprise one or more Document Locations. If the Aggregated Search Results do comprise one or more References the flowchart branches to step 414. If the Aggregated Search Results do not comprise one or more References the flowchart branches to step 415. In step 414 the system displays the Document Locations or, if present, the titles associated with the References comprising the Aggregated Search Results to User A. It should be noted that References may have been given titles, either by the user or automatically by the system based upon the Metadata of the Document, and these titles may be displayed instead of the actual Document Location. In Step 415 the system inform User A that no matches to the Search Term have been found.

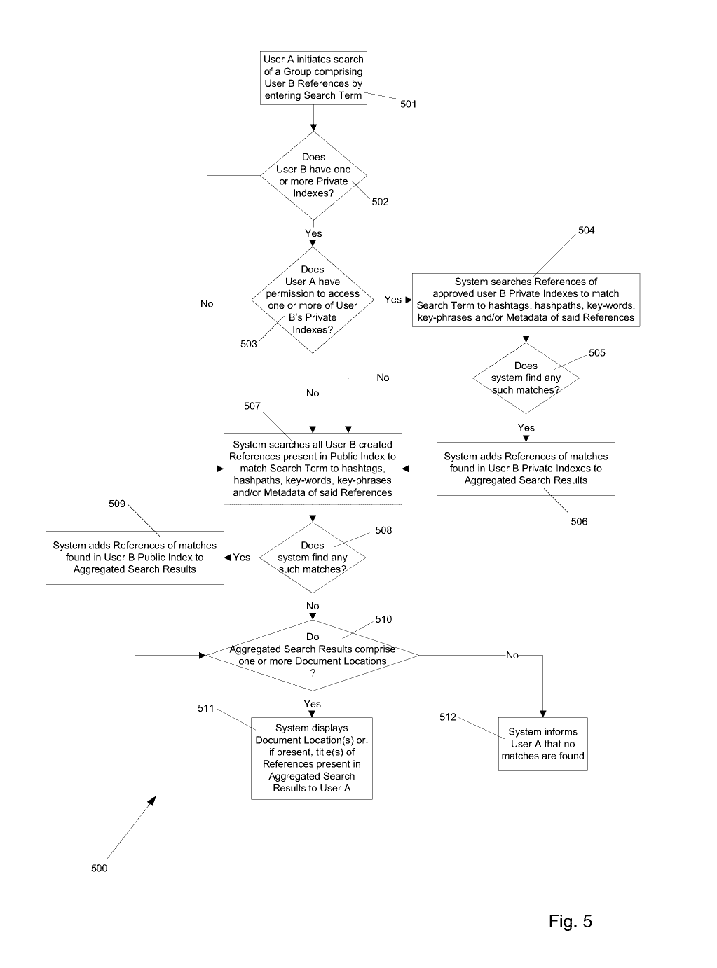

FIG. 5 is a flowchart 500 illustrating an alternate search method of the invention in which a user of the system (User A) searches the References in a second users (User B) Topic Tree. In step 501 user A of the system initiates a search comprising the Group “User B References” by entering a search term such as a keyword, phrase, etc. (the “Search Term”). The flowchart then branches to step 502. In step 502 the system determines if User B has one or more Private Indexes. For example, User B may have a Private Index “Work” that only he has access to. If the system determines that User B does have one or more Private indexes the flowchart branches to step 503. If the system determines that User B does not have one or more Private indexes the flowchart branches to step 507. In step 503 the system determines if User A has permission to access one or more of User B's Private Indexes. For example, User B may have a Private Index “Family” and has only granted password-protected access to this Index of References to specific family members. If the system determines that User A does have permission to access one or more of User B's Private indexes the flowchart branches to step 504. If the system determines that User A does not have permission to access one or more of User B's Private indexes the flowchart branches to step 507. In step 504 the system searches References of User B access approved Private indexes to match the Search Term to the hash tags, hash paths, key-words, key-phrases and/or Metadata of the References in User B's Private Index Topic Trees. The flowchart then branches to step 505. In step 505 the system determines if any such Search Term matches where found. If Search Term matches where found the flowchart branches to step 506. If Search Term matches where not found the flowchart branches to step 507. In step 506 the system adds the References for the matches found in approved User B Private Indexes to the Aggregated Search Results. The flowchart then branches to step 507. In step 507 the system searches all of User B's created References present in the Public Index to match the Search Term to the hash tags, hash paths, keywords, key-phrases and/or Metadata of the References in User B's Public Index Topic Tree. The flowchart then branches to step 508. In step 508 the system determines if any such Search Term matches where found. If Search Term matches where found the flowchart branches to step 509. If Search Term matches where not found the flowchart branches to step 510. In step 509 the system adds the References for the matches found in User B's Public Index to the Aggregated Search Results. The flowchart then branches to step 510. In step 510 the system determines if the Aggregated Search Results comprise one or more Document Locations. If the Aggregated Search Results do comprise one or more References the flowchart branches to step 511. If the Aggregated Search Results do not comprise one or more References the flowchart branches to step 512. In step 511 the system displays the Document Locations or, if present, the titles associated with the References present in the Aggregated Search Results to User A. It should be noted that References may have been given titles, either by the user or automatically by the system based upon the Metadata of the Document, and these titles may be displayed instead of the actual Document Location. In Step 512 the system inform User A that no matches to the Search Term have been found. With respect to Metadata, various items are operated upon according to the present invention. Items or metadata may be collected and stored in the system database when a document is first added to the database (DB) and crawled may include but are not limited to the following; Document location, URL Host domain of URL (added to searchable keys) Document type, Title, Author (s), other key contributors; actors, musicians, bands, directors, architects, associated people of interest, etc. Original publication date publication date to document source, update date(s) if any, language and translation information, genre, rating, explicit content, file size, bit rate, kbps (music and video), DRM scheme (or type), especially for music/video resolution and size (photograph, picture or video), color mode (RGB, Greyscale), landscape or portrait orientation of photograph or video, other EXIF Data, camera and lens type, exposure info etc., time length (film & music), formatting, geo-location and geographic data-sensed (GPS etc), entered from selecting spot on map or manually, cost to view and subscription status of Document—free, paid, subscription price of Document subject—music, film, physical object etc., product ID of Document subject—for example Amazon ID. If two documents in the database (DB) have matching metadata, excluding the Document URL, a relation tag may be added to each document claiming the other Document(s) as a relation or twin. For example there may be several Documents that contain the same content, a specific song for instance, that is identical to the content of one or several other documents in the database. It may also be noted that if a certain percentage of the Document's metadata match that of another Document's, then they may also be considered as related and noted as such.

The system continually checks Documents to make sure they have a valid URL and the Document has not become defunct. If a broken URL is discovered the system will first check for relatives of the Document, twins or documents closely matching metadata and replace the defunct Document with the updated and working replacement. If no active replacement can be found the system will point to a cached version of the Document either stored in the system or on a variety of Internet caching systems such as the Way Back Machine Internet archive. If there is no cached version of the Document the system may simply delete the Document. After the completion of the repair process for the defunct Document the system will update the entire collection associated unique user References to the document so they will still function when accessed by a user. The system may also check Documents that contain a latitude and longitude, or other geo-specific data, to ensure that the object Referenced is still located or doing business at the Referenced location. For example a user may have created a reference to a favorite ice cream parlor in San Francisco. That ice cream parlor has gone out of business and been replaced with a candy shop. By checking available mapping systems such as Google Maps and Bing Maps the system can tell that the identified object, the Document, has changed. It could automatically update the Reference, or ask the user if they would like to update or to delete the Reference since they may not like candy shops and the location is no longer of interest to them. Or if the ice cream parlor had moved to a new location (the system would search the maps for them name of the ice cream parlor to see if a new location was available after it failed to appear in the tagged location), its geo-data would be updated and the Reference would point to the new geo-location of the ice cream parlor. Items automatically added to a Reference may include but are not limited to the following; Document location—URL, location on local computer or home server, title, user ID, privacy settings, date and time of Reference creation, location of user when added, physical location where reference was added, host domain of URL (added to searchable keys), collection the Reference was added to Document metadata, alterations to the Database, a new Reference to an existing Document, changes the Document's ranking (number of associated References) in the DB. The number of times a Document is accessed by the Document's References changes the Document's popularity in the DB. Methods of using stored metadata and hash tags and hash paths in the system are important features of the present invention. Any piece of the sourced, crawled, metadata that is associated with a Document in the database DB may be set by the user, or suggested by the system, to automatically add hash tags and hash paths to a user's References.

A user of the system may be very interested in languages and therefore set the system to automatically add the identified language metadata of a Document to their new Reference entries as hash tags or hash paths. This way when revisiting or searching their References or topic tree they can easily discover Documents that fit their desired criteria. For example a user may want to add a document they discovered relating to the history of the French Revolution to their Reference library. The new Document was originally in French and had been translated to their native language by a person and not a machine translation system such as Google Translate. The Document Reference may automatically be tagged with the following hash path; #language#french#translated#human. If the Document had been translated by machine method the hash path would read; #language#french#translated#machine, perhaps also adding the machine translation method used; #language#french#translated#machine#google. According to the present invention, the hash tags and hash paths would be added to a user's topic tree (for easy reference) by the user, or by others, if the References are tagged as public and not private. Another example of a Document's metadata that may be relevant to certain users of the system is the formatting or file type of a document. Many people access the Internet, its Documents, via devices of varying types and screen sizes. These range from a phone with a small screen to a desktop computer with a large display. It may be desirable for a user accessing the system via their phone to only be shown documents that fit their search criteria, French Revolution, originally in French, translated by a human, but have also been tagged or identified as being formatted properly for their device type. And conversely it may be desirable for a user accessing the system using a large screen from a desktop computer to exclude similarly tagged and formatted Documents. The file type may also be considered if a specific device does not have the ability to play or display a certain type of file. For example Adobe Flash based websites and content are not supported and are therefore un-viewable on an Apple iPhone or iPad. A user concerned with such situations may choose to add the associated Document formatting or file type data to their References when they are being created; #format#mobile or #format#HDTV, or simply #flash, #mobile or #desktop. These hash tags and hash paths would, as with all similarly annotated additions (items with a hashtag or hash path), to a Reference be added to the user's topic tree. The size of a document, its total kilobytes, may also be of concern to users of the system when considering the differing types of access one has to the internet. It may be that when on a slower or perhaps more expensive cellular data connection they restrict their search to Documents that have been tagged with a size below a certain threshold. This metadata may be added to a user's Reference to a Document. #3983 kb for example. A user of the system may be interested in photography and therefore attach, manually or set the system to do so automatically, certain pieces of EXIF data to their References that are associated with documents that are photographs. #nikon#50 mm#f7#ISO400#400thsec#b&w for example. These could be added as a hash path as shown, as individual hash tags or perhaps both or a combination thereof. The user may also only search for photographic Documents that had #canon associated with them or had Canon in their associated metadata or title since they are a user of or a fan of Canon cameras.

Another novel use of the system according to the present invention can be realized when considering the sharing of ones References with the public or with specific groups. For example a professor or teacher may wish to share certain collected References with their students. Since it is likely that the teacher has more than one class they may tag each Reference as specific to that class allowing for the students to easily find Referenced Documents that the teacher deems as important to their class. For example; #ap_english or #anthropology. Hash paths may also be used to further define the intended audience of interest. For example #chemistry#lab_group_3 since lab group three may be conducting an experiment that has relevance to the Referenced Document. Instead of having to email individuals or groups they simply use the system described in this disclosure to communicate with the desired specific parties by annotating a Reference. The system may be set to notify an individual or group via a plurality of means, email, SMS, etc. that a Reference that is annotated to their attention has been added. The system also allows for users to set up sharing groups that allow References to only be shared with a certain group via entering desired user names or emails. This is a more restrictive method. In the case of a professor sharing References a prospective student would not be able to see potential required reading if the references were not tagged as public, but only for a certain group. It is clear that both sharing methods have different utility for certain users of the system. It is of further interest to note the ability of a user to search the public References of specific people, scientists, actors, or others of note (or perhaps just co-workers, friends and others) and use the collected Document metadata and associated Reference metadata in unique ways. For example the user of the system may be looking for articles, Documents, on astrophysics that television host and astrophysicist Neil deGrasse Tyson has created, or added References to, that contain black holes as a topic. It should be noted that using this unique system the user can not only discover what Documents Neil deGrasse Tyson has public References to, and one would assume read, but how many times he has read or viewed a Document he has Referenced. It may be that the most read or viewed Document by Neil deGrasse Tyson about black holes is a very old article, published 20 years ago, but he, for some reason, finds it interesting and noteworthy. Neil deGrasse Tyson created a Reference to the 20 year old article about black holes and has read or viewed it 22 times, most recently one month prior. It can be concluded that the Referenced Document may also be of interest to the user. Now the user has discovered something about that Document that no other service can deliver. Searching for “Neil deGrasse Tyson Black Hole” on the internet will produce an abundance of returns, but none can tell you that Neil deGrasse Tyson himself read, or looked at the returned article even once let alone 22 times. The search results returned by regular web searches will be presented usually by general popularity or by perceived relevance. In the case of news articles on the Internet, searches usually supply results by publication date, which in the case of the twenty-year old article, would be of no help at all. The addition of geo-data to references is a very useful way to organize and view ones References and can be a quick way to build a customized tour or list of things to do and to visit while in a city one may be visiting. Adding latitudes and longitudes and geo-specific hash tags and hash paths to References that one would like to visit or access while in a city, Paris for instance, would be of great utility to a user. They could easily build a list of restaurants for example; #paris#restaurant#breakfast#leboulanger or #paris#restaurant#dinner#septime. While in Paris they could set the system to only display References that conform to their current geo-location. The References could be displayed in a list, accessed from the topic tree or be displayed on a map. It may also be of interest to users to visit locations, or simply access location specific Documents, which others have found to be of note. For example the celebrity chef and television star Anthony Bourdain often visits cities around the world and creates television shows about those cities. One could hashtag the places he has been, #paris#bourdain#restaurant#robertetlouise or #paris#bourdain#tourism#catacombs and easily recall them while in that city. This would be even easier if Anthony Bourdain was a user of the system and made public References to places he has visited and added to the system.

A user's location when they add a Document Reference is logged by the system. This may be of interest in certain situations. For example a user is visiting the American Museum of Natural History are viewing the astrophysics displays. They could easily see if Neil deGrasse Tyson had created any Document References while he visited the museum or even if he had accessed another's Referenced Document while in the museum.

When looking for a Document, particularly one publicly referenced by another party, it would be advantageous for the user to restrict the search to Documents that fit certain payment and subscription parameters. If the user does not have a paid subscription to a site such as the New York Times certain content may be unavailable to them and therefore it would be desirable to exclude New York Times articles from any searches. The same exclusions could be made for Referenced content that was unavailable to a user such as music on paid services, movies an television on Netflix or Hulu if the user did not have subscription. These payment and subscription parameters could be set and stored in a user's profile. Only show me content I can see without additional payment. They system may be able suggest a twin or related Document as an alternative that fit a user's payment and subscription parameters if a reference is of particular interest and therefore the content highly desired by the user.

Users of the system may find themselves accessing the Referenced Documents form different location around the globe. It may be that certain content may be restricted and illegal in certain geographic locations and therefore any search of Referenced Documents could exclude References to Documents that contained illicit or illegal content based os the Documents sourced or added metadata. For example rated X films are illegal in many party of the world and any Reference to Documents that had been tagged with an X rating would be excluded based on the users physical geographic location.

FIG. 6 is an image 600 showing a representation of a possible user interface of the invention (the “UI”) for the user “Tom Ellenby” (the “User”). The UI indicates that the User has a total of five References 601 in his Topic Tree. Note that the Reference may be saved on multiple branches of the Topic Tree depending on the hash tags and/or hash paths of the Reference. The UI also includes a graphic area 602 showing the Topic Tree of the user. The first level Topic Tree branch “weather” 603 has been selected and the references in the “weather” branch and its related second level (“hurricane”) and third level (“tropical”) branches are displayed in UI graphic area 604. It should be noted that while the Topic Tree UI 602 indicates that there are four References total 605 present in the “weather” branch only three References are displayed in UI graphic area 604. This is because the Reference titled “World Weather Radar” includes both a hash tag “#weather” and a hashpath “#weather#radar” and hence this Reference is present in two branches of the Topic Tree (the first level “weather” branch and the second level “weather/radar” branch). The Reference titled “Weather Underground Tropical Weather is only present in the third level weather/hurricane/tropical branch of the Topic Tree. It should also be noted that the Reference titled “The birth of the weather forecast” is present in the first level branches “prediction”, “forecast”, Forecasting” and “history” as well as the first level branch “weather”.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

Embodiments presented are particular ways to realize the invention and are not inclusive of all ways possible. Therefore, there may exist embodiments that do not deviate from the spirit and scope of this disclosure as set forth by appended claims, but do not appear here as specific examples. It will be appreciated that a great plurality of alternative versions are possible.

What is claimed is:

1. A method for creating a document reference for use by a primary user performing a search desiring to be part of a searching group of users comprising the steps of:
a primary user searching for primary information, wherein said searching includes searching based on metadata and based on content stored;
a document reference generator for storing additional information associated with said primary information, and
a computer for combining said primary information and said additional information to create said document reference, wherein said primary user performing a search of primary information may perform a search and acquire search metadata which were stored prior to said primary user search in response to metadata added previously by any of a set of previous user interactions with said computer, and further, wherein said primary user selects which of said previous user generated metadata are to be considered by said primary user in selecting a desired set of information.

2. A method of claim 1, wherein said additional information is one or more keywords.

3. A method of claim 1, wherein said additional information is one or more keywords in addition to at least one non-alphanumeric symbol.

4. A method of claim 1, wherein said additional information is one or more contiguous strings of keywords each preceded by at least one non-alphanumeric symbol.

5. A method of claim 1, wherein said additional information is metadata generated by crawling the content of said document or said document location.

6. A method of claim 1, wherein said primary information includes an Internet URL.

7. A method of claim 1, wherein said primary information document including html web-page.

8. A method of claim 1, wherein said primary information is a text document.

9. A method of claim 1, wherein said primary information is a still or moving video image.

10. A method of claim 1, said primary information is a music file.

11. A method for adding a document reference to a hierarchy of document references comprising the steps of:
determining if said document reference to be added to a hierarchy of document references includes one or more keywords preceded by a non-alphanumeric symbol or a contiguous string of keywords each preceded by a non-alphanumeric symbol, and
further determining if said hierarchy of document references currently includes locations related to each said keyword preceded by a non-alphanumeric symbol or contiguous strings of key-words each preceded by a non-alphanumeric symbol, and
adding said document reference to all said locations in said hierarchy related to said key-word preceded by a non-alphanumeric symbol or contiguous strings of key-words each preceded by a non-alphanumeric symbol, and
generating new locations in said hierarchy for those key-word preceded by a non-alphanumeric symbols and contiguous strings of key-words each preceded by a non-alphanumeric symbol that do not currently have a location in said hierarchy associated with them and adding same to said new locations in said hierarchy.

12. A method according to claim 11, wherein said contiguous strings of keywords are each preceded by a non-alphanumeric symbol being further defined as comprising numerically labeled elements, and generating new locations in said hierarchy for those contiguous strings of key-words each preceded by a non-alphanumeric symbol that do not currently have a location in said hierarchy associated with them being further defined comprising the steps of:
determining if said hierarchy of document references currently includes locations related to the first key-word preceded by a non-alphanumeric symbol in said contiguous string, and
generating a new branch of said hierarchy comprising numerically labeled branches for those contiguous strings of keywords each preceded by a non-alphanumeric symbol whose first keyword do not currently have a location in said hierarchy associated with them.

13. A method of claim 11, wherein said contiguous strings of keywords each preceded by a non-alphanumeric symbol being further defined as comprising numerically labeled elements, and generating new locations in said hierarchy for those contiguous strings of key-words each preceded by a non-alphanumeric symbol that do not currently have a location in said hierarchy associated with them being further defined comprising the steps of:
determining if said hierarchy of document references currently includes locations related to the first key-word preceded by a non-alphanumeric symbol in said contiguous string, and
for those contiguous strings of key-words each preceded by a non-alphanumeric symbol whose first key-word does currently have a location in said hierarchy associated with them determining if said hierarchy of document references currently includes locations related to the second key-word preceded by a non-alphanumeric symbol in said contiguous string, and
generating a new branch of said hierarchy associated with element 1 of said contiguous string comprising numerically labeled branches for those contiguous strings of keywords each preceded by a non-alphanumeric symbol whose second key-word do not currently have a location in said hierarchy associated with them.

14. An apparatus for searching a hierarchy of document references comprising including a computer with associated memory and available online information:
a first user data interface suitable for entry of a search term;
a criteria memory element containing information relating to search scope specified by said first user of said apparatus defining search scope, and
said system comparing applying said search term to said search scope specified by said first user.

15. A method for searching a hierarchy of document references of a system comprising the steps of:
a first user of the system defining a search term, and
said first user of the system defining a search scope, and
said system applying said search term to said search scope.

16. A method of claim 15, said search scope being further defined as the reference hierarchy associated with said first user of the system.

17. A method of claim 15 said search scope being further defined as the reference hierarchy associated with said first user of the system and the reference hierarchy associated with a second user of the system.

18. A method of claim 15, said reference hierarchy associated with said second user of the system being further defined as including sections denoted as public and private.

19. A method of claim 15, said search scope being further defined as the reference hierarchy associated with said first user of the system, and the sections of the reference hierarchy associated with said second user of the system that are denoted as public, and the sections of the reference hierarchy associated with said second user of the system that are denoted as private and that said first user of the system is authorized to access.

20. A method of claim 15, said search scope being further defined as the reference hierarchy associated with said first user of the system, and the sections of the reference hierarchy associated with said second user of the system that are denoted as private and that said first user of the system is authorized to access.

21. A method of claim 15, said search scope being further defined as the reference hierarchy associated with a second user of the system.

22. A method of claim 15, said reference hierarchy associated with said second user of the system being further defined as including sections denoted as public and private.

23. A method of claim 15, said search scope being further defined as the sections of the reference hierarchy associated with said second user of the system that are denoted as public, and the sections of the reference hierarchy associated with said second user of the system that are denoted as private and that said first user of the system is authorized to access.

24. A method of claim 23, said search scope being further defined as the sections of the reference hierarchy associated with said second user of the system that are denoted as private and that said first user of the system is authorized to access.

25. A method of claim 23, said search term being further defined as a single word.

26. A method of claim 23, said search term being defined as a phrase or word string.

27. A method of claim 23, said search term being further defined as Boolean search parameters.
